(19) United States
(12) Patent Application Publication
(10) Pub. No.: US 2010/0320189 A1
(43) Pub. Date: Dec. 23, 2010

(54) AUTOMATED USER-CUSTOMIZED COOKING APPLIANCE CONFIGURATION

(76) Inventor: BRIAN K. BUCHHEIT, DAVIE, FL (US)

Correspondence Address: PATENTS ON DEMAND, P.A.-General, 4581 WESTON ROAD, SUITE 345, WESTON, FL, 33331, US

(21) Appl. No.: 12/487,437

(22) Filed: Jun. 18, 2009

(51) Int. Cl. H05B 1/00; B65D 81/34

(52) U.S. Cl. 219/488; 426/107

(57) ABSTRACT

A solution to automatically configure a cooking appliance can include an automated cooking instruction handler. The automated cooking instruction handler can be coupled with the cooking appliance and can receive recommended cooking instructions and item identification data from a data storage medium of a packaged food item. The recommended cooking instructions can define recommended values for the cooking parameters of the cooking appliance. The identity of a human user, who intends to utilize the cooking appliance to cook the packaged food item, can be ascertained. The existence of user-defined cooking preferences for the packaged food item and human user can be determined. The user-defined cooking preferences can describe user-configured values for cooking parameters. When user-defined cooking preferences exists, a customized cooking process can be automatically synthesized from the recommended cooking instructions and the user-defined cooking preferences. The customized cooking process can be provided to the cooking appliance for execution.

### BACKGROUND

The present invention relates to the field of cooking appliances and, more particularly, to the automated user-customized configuration of cooking appliances. As people's lives become busier, they desire faster and more efficient means of performing menial and/or often repeated tasks such as those related to cooking packaged food items. Many packaged food items provide generic or recommended cooking instructions upon the packaging. A human user must program their desired cooking appliance to comply with the recommended cooking instructions.

Often times, the user does not enter the recommended cooking instructions as they appear on the package. These entry mistakes are made unintentionally, as in the case of user error, or intentionally to accommodate the user's preference or a lack in functionality of the cooking appliance. For example, a user may prefer a crispier pizza crust, leading them to cook their pizza a minute longer than recommended on the package.

Regardless of the nature of the entry discrepancy, the cooking appliance is ill-equipped to handle these situations. For example, a user can inadvertently enter a cooking time to make microwave popcorn that results in not only burning the popcorn, but also starting a fire. Further, the user is required to repeatedly enter their cooking preference every time they cook the specific food item.

### SUMMARY

One aspect of the present disclosure can include a method for automatically configuring a cooking appliance. In the method, cooking instructions digitally encoded in a data storage medium coupled to a packaged food container including edible food can be read with a data reader connected to a cooking appliance. The cooking instructions can be decoded to acquire cooking parameters. The cooking parameters can include a cooking time and a cooking power. Cooking appliance settings can be adjusted to the cooking time and the cooking power. The cooking appliance can be activated at the adjusted cooking appliance settings to prepare food based at least in part upon the acquired cooking parameters read from the data storage medium.

Another aspect of the present disclosure can include a packaged food item that includes edible food to be prepared by a cooking appliance and a data storage medium coupled to a package that includes the edible food. The data storage medium can include digitally encoded cooking instructions able to be directly read by the cooking appliance. The digitally encoded cooking instructions can define cooking parameters for the cooking appliance. The digitally encoded cooking instructions can include at least a cooking time and a cooking power for preparing the edible food.

Another aspect of the present disclosure can include a cooking appliance including a cooking element, appliance circuitry, a data reader, and a processor. The cooking element can prepare food. The appliance circuitry can control a cooking power of the cooking element and a cooking time for which the cooking element is activated. The data reader can read cooking instructions from a data storage medium of a packaged food item, where said read cooking instructions are specific to edible food within a packaged food item. The processor can adjust appliance settings in accordance with cooking instructions read by the data reader. The adjusted appliance settings from the processor can cause adjustments in the appliance circuitry, where the adjustments include a cooking time and a cooking power.

Another aspect of the present disclosure can include a method for automatically configuring a cooking appliance. An automated cooking instruction handler coupled with a cooking appliance can receive recommended cooking instructions and item identification data from a data storage medium of a packaged food item. The recommended cooking instructions can define recommended values for one or more cooking parameters of the cooking appliance. The identity of a human user, intending to utilize the cooking appliance to cook the packaged food item, can then be ascertained. The existence of user-defined cooking preferences for the packaged food item and associated with the human user can be determined. The user-defined cooking preferences can describe user-configured values for the cooking parameters of the cooking appliance. When user-defined cooking preferences exists, a customized cooking process can be automatically synthesized from the recommended cooking instructions and the user-defined cooking preferences. The customized cooking process can be provided to the cooking appliance for execution.

Another aspect of the present disclosure can include a system for automatically configuring a cooking appliance. Such a system can include recommended cooking instructions, a data storage medium, user-defined cooking preferences, and an automated cooking instruction handler. The recommended cooking instructions can define the recommended values for the cooking parameters of a cooking appliance. The data storage medium can be coupled with a packaged food item and can be configured to store and provide access to the recommended cooking instructions and item identification data for the packaged food item. The user-defined cooking preferences can describe user-configured values for cooking parameters. The automated cooking instruction handler can be coupled with the cooking appliance and can be configured to synthesize a customized cooking process for cooking the packaged food item within the cooking appliance. The customized cooking process can be synthesized from the recommended cooking instructions and the user-defined cooking preferences. The user-defined cooking preferences can be given priority over corresponding recommended cooking instructions.

Another aspect of the present disclosure can include a computer program product that can include a computer readable storage medium having embedded computer usable program code. The computer usable program code can be configured to receive recommended cooking instructions and item identification data from a data storage medium coupled with a packaged food item. The recommended cooking instructions can define the recommended values for the cooking parameters of a coupled cooking appliance. The computer usable program code can be configured to ascertain an identity of a human user of the coupled cooking appliance. Further, the computer usable program code can be configured to determine the existence of user-defined cooking preferences for the packaged food item and the human user. The user-defined cooking preferences can describe user-configured values for the cooking parameters of the coupled cooking appliance. When user-defined cooking preferences exist, the computer usable program code can be configured to automatically synthesize a customized cooking process based upon the recommended cooking instructions and the user-defined cooking preferences. The computer usable program code can be further configured to provide the customized cooking process to the coupled cooking appliance for execution.

### BRIEF DESCRIPTION OF THE SEVERAL VIEWS OF THE DRAWINGS

FIG. 1 is a schematic diagram illustrating a system that provides automated user-customized configuration of a cooking appliance in accordance with embodiments of the inventive arrangements disclosed herein.

FIG. 2 is a schematic diagram illustrating a detailed embodiment of a system that provides automated user-customized configuration of a cooking appliance in accordance with an embodiment of the inventive arrangements disclosed herein.

FIG. 3 is a collection of sample data illustrating the synthesis of a customized cooking process in accordance with embodiments of the inventive arrangements disclosed herein.

FIG. 4 is a flow chart of a method that describes the automatic generation of a test execution plan performed by a test execution plan generation tool in accordance with embodiments of the inventive arrangements disclosed herein.

### DETAILED DESCRIPTION

The present invention discloses a solution that can automatically configure a cooking appliance to cook a packaged food item. Recommended cooking instructions and item identification data can be stored within a data storage medium coupled with a packaged food item. An automated cooking instruction handler coupled with the cooking appliance can receive the recommended cooking instructions and item identification data from the data storage medium. The automated cooking instruction handler can then receive user identification data and determine applicable user-defined cooking preferences for the packaged food item and user. From the user-defined cooking preferences and the recommended cooking instructions, the automated cooking instruction handler can synthesize a customized cooking process to be used by the cooking appliance to cook the packaged food item.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, for instance, via optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

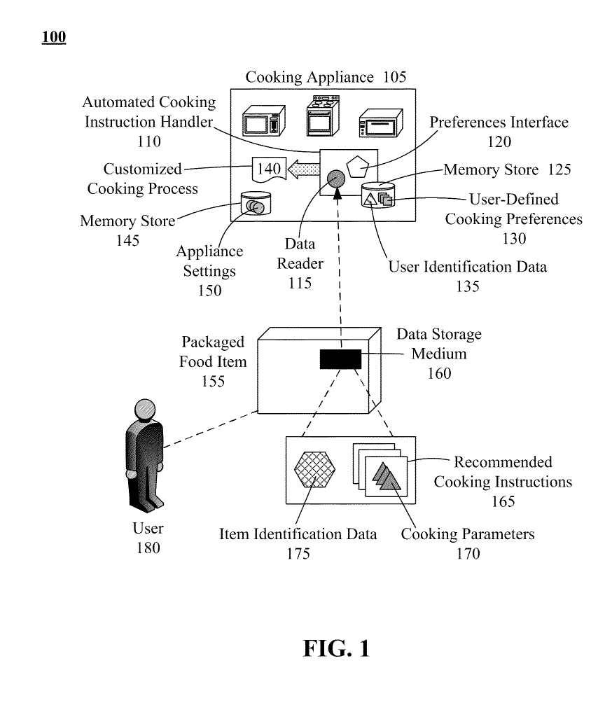

FIG. 1 is a schematic diagram illustrating a system 100 that provides automated user-customized configuration of a cooking appliance 105 in accordance with embodiments of the inventive arrangements disclosed herein. In system 100, a cooking appliance 105 can be automatically configured with a customized cooking process 140 for the user 180 to cook the packaged food item 155.

The user 180 can obtain a packaged food item 155. The packaged food item 155 can represent a variety of food items packaged in a variety of manners. Examples of packaged food items 155 can include, but are not limited to, food items in cardboard/paper packaging, food items in plastic packaging, canned food items, food items in glass jars, and the like. The packaged food item 155 can include data storage medium 160 containing recommended cooking instructions 165, item identification data 175, and other data. The item identification data 175 can define all food by type that the edible food of packaged food item 155. The other data can include, for example, nutrition facts of the edible food, such as calories of the edible food, fat of the edible food, protein of the edible food, vitamins of the edible food, and the like.

The data storage medium 160 can represent the means for storing the recommended cooking instructions 165 and item identification data 175. The data storage medium 160 can be integrated into the packaging of the packaged food item 155 and/or attached to the packaged food item 155. For example, the data storage medium 160 can be represented by a bar code printed upon a surface of the packaged food item 155. In another example, the data storage medium 160 can be a Radio Frequency Identification (RFID) tag comprising digitally encoded instructions 165. In still another embodiment, instructions 165 can be audibly encoded, where the medium 160 can generate acoustic signals (e.g., comprise an audio transducer, such as a speaker) having encoded instructions, which are read by the data reader 115 (e.g., a microphone and processor that decodes the audibly encoded instructions 165.) Any of a variety of storing and reading technologies can be utilized herein for storing the instructions 165, such as RFID technology, barcode technologies, BLUETOOTH, WIFI, Wireless USB, technologies, the SD-X technology used by POINGO devices, the technology used by LEAPFROG TAG system devices, audio playback/reception/encoding, and the like.

The recommended cooking instructions 165 can be an electronic representation of the basic instructions provided for cooking the packaged food item 155. The recommended cooking instructions 165 can include the recommended values for one or more cooking parameters 170. A cooking parameter 170 can correspond to a specific cooking attribute utilized by the cooking appliance 105. For example, a written instruction stating “Cook on high for 3 minutes” can be represented as a recommended cooking instruction 165 having the cooking parameters 170 “Power=High” and “Cook Time=3 minutes”.

Additionally, the role of the recommended cooking instructions 165 can be expanded to include important auxiliary information, such as safety values. For example, the recommended cooking instructions 165, “Cook on high for 3 minutes”, can also include a cooking parameter 170 indicating that the cook time should not exceed 5 minutes. This additional cooking parameter 170, while allowing room for adjustment by the user 180, can help to avoid a hazardous situation for the cooking appliance 105, such as a cooking fire.

The item identification data 175 can be one or more pieces of electronic information that uniquely identifies the packaged food item 155. Examples of item identification data 175 can include, but are not limited to, a product name, a universal product code (UPC), a manufacturer-specific product identifier, and the like.

The user 180 can move the packaged food item 155 towards the desired cooking appliance 105. The cooking appliance 105 can represent a variety of electronic devices utilized to cook food items, including, but not limited to, a microwave oven, a toaster oven, a conventional oven, a pressure cooker, a barbecue grill, and the like. The cooking appliance 105 can include an automated cooking instruction handler 110 and a memory store 145 containing appliance settings 150.

The appliance settings 150 can be electronic representations of standard cooking settings supported by the cooking appliance 105. The appliance settings 150 can conform to the same standardized format as the recommended cooking instructions 165. As such, appliance settings 150 can consist of cooking parameters 170 whose values are preset by the manufacturer. For example, the “Popcorn” setting 150 of a microwave oven 105 can be expressed as “Power=100%” and “Cook Time=3 minutes”.

The automated cooking instruction handler 110 can represent the hardware and/or software elements configured to automatically provide the cooking appliance 105 with a customized cooking process 140. The automated cooking instruction handler 110 can include a data reader 115, a preferences interface 120, and a memory store 125 containing user-defined cooking preferences 130 and user identification data 135.

In an alternate embodiment, memory stores 125 and 145 can refer to a single storage location in which the appliance settings 150, user identification data 135, and user-defined cooking preferences 130 are stored.

The data reader 115 can represent the hardware and/or software elements configured to retrieve the recommended cooking instructions 165 and item identification data 175 from the data storage medium 160 of the packaged food item 155. For example, the data reader 115 can be a radio frequency identification (RFID) reader capable of reading information from a RFID tag 160.

It should be noted that the data reader 115 must correlate to the type of data storage medium 160 used with the packaged food item 155. That is, a bar code reader 115 cannot be used to read a RFID tag 160, nor a RFID reader 115 to read a bar code 160. As such, in an alternate embodiment, the automated cooking instruction handler 110 can include multiple data readers 115 for handling multiple types of data storage media 160.

The preferences interface 120 can represent the mechanism by which the user-defined cooking preferences 130 are captured. The preferences interface 120 can be configured to utilize the standard elements of the cooking appliance 105, such as a keypad and visual display. Since user-defined cooking preferences 130 are user-specific, the preferences interface 120 can also include the means for capturing the user identification data 135.

The user identification data 135 can represent the electronic data that uniquely identifies a user 180. Once the user identification data 135 can is defined for a user 180, user-defined cooking preferences 130 can be captured and customized cooking process 140 created for that user 180. Identification of a user 180 by the automated cooking instruction handler 110 can be performed in a variety of manners. For example, in a simple implementation, the user 180 can select their user identification data 135 (e.g., select User 1) each time they utilize the cooking appliance 105. A more complex implementation can utilize biometric sensors to automatically determine the appropriate user identification data 135 from the captured biometric data.

The user-defined cooking preferences 130 can be electronic representations of user-specific modifications to the recommended cooking instructions 165. The user-defined cooking preferences 130 can conform to the same standardized format as the recommended cooking instructions 165 and appliance settings 150. For example, a user 180 preferring a crispier crust on their microwave pizza 155 can store the user-defined cooking preference 130 indicating “Cook Time=6 minutes” instead of the “Cook Time=5 minutes” contained in the recommended cooking instructions 165.

Since the user-defined cooking preferences 130 are stored within the memory store 125, repeated entry of this information by the user 180 can be eliminated for applicable subsequent cooking activities. Building upon the previous example, every time the user 180 cooks that brand of microwave pizza 155, the customized cooking process 140 generated by the automated cooking instruction handler 110 can reflect the six minute cooking time without user 180 intervention.

The customized cooking process 140 can be an electronic representation of the aggregated cooking parameters 170 defining how the cooking appliance 105 should be configured to cook the packaged food item 155. The automated cooking instruction handler 110 can synthesize the customized cooking process 140 from the recommended cooking instructions 165, appliance settings 150, and user-defined cooking preferences 130. Once generated, the customized cooking process 140 can be provided to the cooking appliance 105 for execution.

In another contemplated embodiment, the automated cooking instruction handler 110 can be an external component coupled with the cooking appliance 105. In such an embodiment, communication between the automated cooking instruction handler 110 and the cooking appliance 105 can utilize a variety of wired and/or wireless protocols.

As used herein, presented memory stores 125 and 145 can be a physical or virtual storage space configured to store digital information. Memory stores 125 and 145 can be physically implemented within any type of hardware including, but not limited to, a magnetic disk, an optical disk, a semiconductor memory, a digitally encoded plastic memory, a holographic memory, or any other recording medium. Memory stores 125 and 145 can be a stand-alone storage unit as well as a storage unit formed from a plurality of physical devices. Additionally, information can be stored within memory stores 125 and 145 in a variety of manners. For example, information can be stored within a database structure or can be stored within one or more files of a file storage system, where each file may or may not be indexed for information searching purposes. Further, memory stores 125 and/or 145 can utilize one or more encryption mechanisms to protect stored information from unauthorized access.

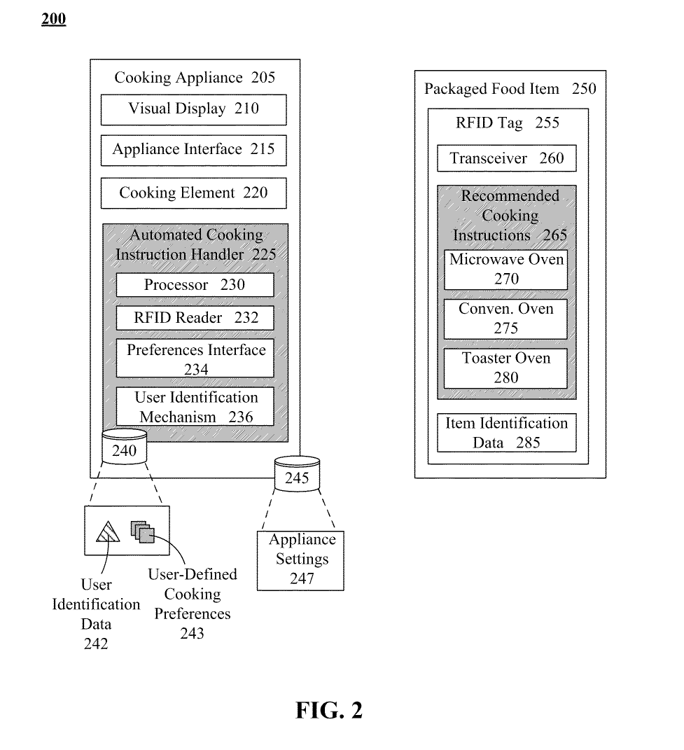

FIG. 2 is a schematic diagram illustrating a detailed embodiment of a system 200 that provides automated user-customized configuration of a cooking appliance 205 in accordance with embodiments of the inventive arrangements disclosed herein. System 200 can represent a specific embodiment of system 100. System 200 shows a RFID reader 232 and operates based upon RFID technology, but the disclosure is not to be construed as limited in this regard. For example, in an alternative configuration, a bar code reader (and bar code technology), or a wireless data exchange technology (e.g., Bluetooth, WIFI, wireless USB, etc.) can be substituted for the RFID reader 232 to achieve a similar effect of reading data from a package, to change an appliance setting based upon this package specific data, and to prepare/cook food of the package in accordance with the package specific data.

System 200 can include cooking appliance 205 and packaged food item 250. The cooking appliance 205 can include a visual display 210, an appliance interface 215, a cooking element 220, an automated cooking instruction handler 225, and a memory store 245 containing appliance settings 247.

It should be noted that the components of the cooking appliance 205 shown in system 200 are for illustrative purposes only, and, are not intended to present a definitive or limiting representation.

The visual display 210 can be configured to visually and/or graphically present information to a user of the cooking appliance 205. For example, a microwave oven 205 can have a visual display 210 that presents the remaining amount of cooking time. Further, the visual display 210 can visually present user-entered information, such as an inputted power level.

The appliance interface 215 can represent a variety of mechanisms utilized by a user to provide the cooking appliance 205 with information. Examples of an appliance interface 215 can include, but are not limited to, a touch screen, a push button, a keypad, a voice recognition interface, a mechanical switch, a knob, and the like.

The cooking element 220 can represent the means utilized by the cooking appliance 205 to heat the packaged food item 250, such as the heating element 220 of an electric stove. The type and quantity of cooking elements 220 can vary based on the cooking appliance 205.

The automated cooking instruction handler 225 can include a processor 230, a radio frequency identification (RFID) reader 232, a preferences interface 234, a user identification mechanism 236, and a memory store 240 containing user identification data 242 and user-defined cooking preferences 243. The processor 230 can represent the hardware and/or software necessary to execute the software commands defining the functions of the automated cooking instruction handler 225.

In another embodiment, the processor 230 can be a component of the cooking appliance 205 that can be utilized by the automated cooking instruction handler 225.

The RFID reader 232 can represent a specific implementation of the data reader 115 of system 100. The RFID reader 232 can be configured to utilize radio waves to retrieve data from a RFID tag, such as the RFID tag 255 of the packaged food item 250.

The preferences interface 234 can include the interaction mechanisms and/or supporting functionality for capturing the user-defined cooking preferences 243. The preferences interface 234 can also be configured to utilize the visual display 210 and/or appliance interface 215. For example, the user can input a value for a user-defined cooking preference 243 via the keypad 215 with the value presented in the visual display 210.

The user identification mechanism 236 can represent the means by which the automated cooking instruction handler 225 captures user identification data 242, information that uniquely identifies a user. The user identification mechanism 236 can be configured to utilize the visual display 210 and/or appliance interface 215 of the cooking appliance 205. Alternately, the user identification mechanism 236 can be a separate, specialized component, such as a fingerprint scanner.

The packaged food item 250, in addition to the actual food item, can include a RFID tag 255, which can represent the data storage medium 160 of system 100. It should be noted that the specific components of the RFID tag 255 are dependent upon the type of RFID tag 255 used. That is, a passive RFID tag 255, such as the one shown in system 200, does not require an internal power supply. However, an active RFID tag 255 would require the addition of a power supply component to the RFID tag 255.

The RFID tag 255 can include a transceiver 260, recommended cooking instructions 265, and item identification data 285. The transceiver 260 can represent the component of the RFID tag 255 that allows communication with the RFID reader 232.

The data portion of the RFID tag 255 can include the recommended cooking instructions 265 and item identification data 285. The recommended cooking instructions 265 can include subgroups of data specific to the various types of cooking appliances 205 that can be used to cook the packaged food item 250. As shown in this example, the recommended cooking instructions 265 can contain subgroups for a microwave oven 270, a conventional oven 275, and a toaster oven 280.

The automated cooking instruction handler 225 can include additional logic to determine which subgroup of recommended cooking instructions 265 to utilize for the cooking appliance 205 to which the automated cooking instruction handler 225 is coupled.

As used herein, presented memory stores 240 and 245 can be a physical or virtual storage space configured to store digital information. Memory stores 240 and 245 can be physically implemented within any type of hardware including, but not limited to, a magnetic disk, an optical disk, a semiconductor memory, a digitally encoded plastic memory, a holographic memory, or any other recording medium. Memory stores 240 and 245 can be a stand-alone storage unit as well as a storage unit formed from a plurality of physical devices. Additionally, information can be stored within memory stores 240 and 245 in a variety of manners. For example, information can be stored within a database structure or can be stored within one or more files of a file storage system, where each file may or may not be indexed for information searching purposes. Further, memory stores 240 and/or 245 can utilize one or more encryption mechanisms to protect stored information from unauthorized access.

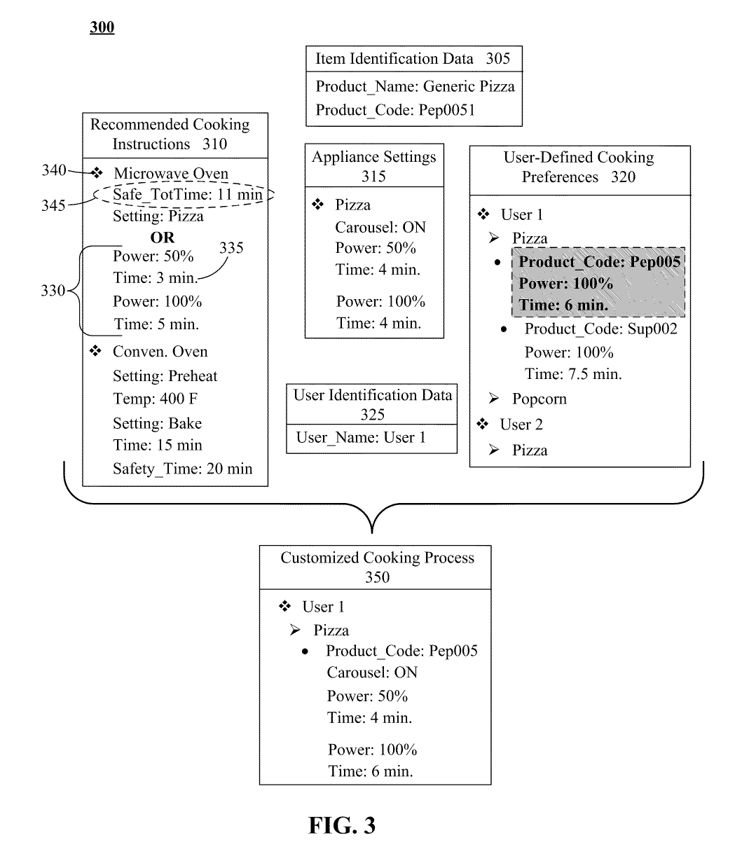

FIG. 3 is a collection 300 of sample data 305, 310, 315, 320, and 325 illustrating the synthesis of a customized cooking process 350 in accordance with embodiments of the inventive arrangements disclosed herein. The sample data 305, 310, 315, and 320 of collection 300 can be utilized within the context of systems 100 and/or 200.

The sample data used to synthesize a customized cooking process 350 can include item identification data 305, recommended cooking instructions 310, appliance settings 315, user-defined cooking preferences 320, and user identification data 325. Each set of sample data 305, 310, 315, 320, and 325 can include cooking parameters 330 with associated values 335. For illustrative purposes, the sample data 305, 310, 315, 320, and 325 will be used in an example synthesis of a customized cooking process 350 for cooking a pizza in a microwave oven by a user identified as “User 1”.

In this example, the item identification data 305 contains two cooking parameters 330 identifying the associated packaged food item—a product name and a product code. Since this example is for “User 1”, the user identification data 325 can indicate that the User_Name 330 has a value 335 of “User 1”.

The cooking parameters 330 of the recommended cooking instructions 310 can have two subgroup headings 340—one for a microwave oven and one for a conventional oven. As shown in this example, the recommended cooking instructions 310 for the microwave oven 340 can include BOOLEAN logic. This can be translated as indicating that the cooking parameters 330 for the “Pizza” appliance setting 315 of the microwave oven should be used or the second group of cooking parameters 330 can be used should a “Pizza” appliance setting 315 not exist.

Additionally, the recommended cooking instructions 310 can include one or more safety cooking instructions 345. The safety cooking instruction 345 can provide an additional limitation for a cooking parameter 330 to minimize potential hazardous situations. Thus, in this example, the recommended cooking instructions 310 for cooking the pizza in the microwave oven indicate utilizing the “Pizza” appliance setting 315 or, should that setting be unavailable, cooking the pizza for three minutes at 50% power and another five minutes at 100% power, with the total cooking time not exceeding eleven minutes.

The appliance settings 315 can illustrate cooking parameters 330 and value 335 grouped by predefined headings 340. These groups of cooking parameters 330 and values 335 can represent the settings supported by the cooking appliance that were preset by the manufacturer such as the “Popcorn” button or setting commonly available with microwave ovens. As shown this example, the preset “Pizza” appliance setting 315 activates the carousel, cooks the pizza at 50% power for four minutes, and another four minutes at 100% power.

The user-defined cooking preferences 320 can include cooking parameters 330 and values 335 for multiple users, multiple food groups, and/or multiple food items. Based on the user identification data 325 and item identification data 305, the applicable user-defined cooking preferences 320 can be identified. In this example, the highlighted cooking parameters 330 are applicable, indicating that the cooking time of the pizza at 100% power should be increased to six minutes.

The customized cooking process 350 created from the sample data 305, 310, 315, 320, and 325 can be read as follows. To cook the pizza with a product code of Pep005 for the user identified as User 1 in the microwave oven, activate the carousel, cook the pizza for four minutes at 50% power, and six minutes at 100% power.

It should be noted that the resolution and/or precedence of values 335 of the same cooking parameter 330 indicated in the recommended cooking instructions 310 and appliance settings 315 can vary based on the implementation of the automated cooking instruction handler.

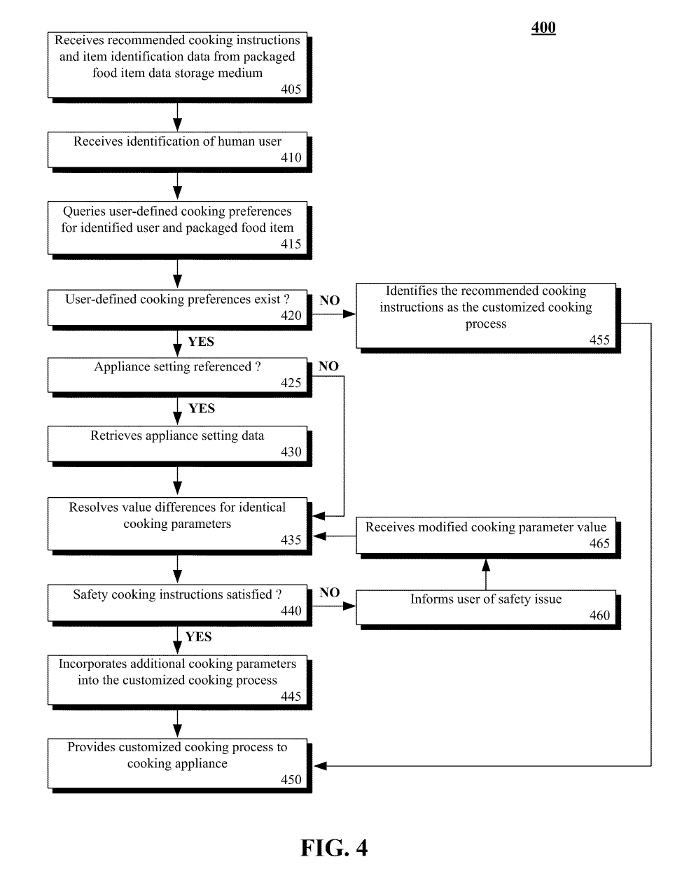

FIG. 4 is a flow chart of a method 400 that describes the generation of a customized cooking process by a automated cooking instruction handler to configure a cooking appliance in accordance with an embodiment of the inventive arrangements disclosed herein. Method 400 can be performed by systems 100, 200, and/or utilizing the sample data of collection 300.

Method 400 can begin with step 405 where the automated cooking instruction handler can receive the recommended cooking instructions and item identification data from the data storage medium of a packaged food item. Identification of the human user can be received in step 410. In step 415, the user-defined cooking preferences can be queried for those matching the identified user and the packaged food item.

In step 420, it can be determined if user-defined cooking preferences exist for the identified user and packaged food item. When user-defined cooking preferences exist, it can be determined if any appliance setting is referenced in step 425. When an appliance setting is referenced, step 430 can execute where the appliance setting data can be retrieved.

Upon completion of step 430 or when it is determined that an appliance setting is not referenced, step 435 can execute where the automated cooking instruction handler resolves value differences for identical cooking parameters. In step 440, it can be determined if the safety cooking instructions have been satisfied.

When a safety cooking instruction has not been satisfied, flow can proceed to step 460 wherein the user can be informed of the safety issue. In step 465, a modified cooking parameter value can be received. From step 465, flow can return to step 435 for the resolution of values and re-examination of the safety cooking instructions.

In an alternate embodiment, the modified cooking parameter can be replaced with an override indicator to allow the use of the entered value. In such a case, flow would proceed to step 445.

Once all safety cooking instructions have been satisfied, step 445 can execute where the additional cooking parameters, those without matches between the data sources, can be incorporated into the customized cooking process. The customized cooking process can be provided to the cooking appliance in step 450.

When it is determined in step 420 that user-defined cooking preferences do not exist for the identified user and/or packaged food item, step 455 can execute where the recommended cooking instructions can be identified as the customized cooking process. From step 455, flow can then proceed to step 450 where the customized cooking process can be provided to the cooking appliance.

The diagrams in FIGS. 1-4 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for automatically configuring a cooking appliance comprising:
reading cooking instructions digitally encoded in a data storage medium coupled to a packaged food container comprising edible food with a data reader connected to a cooking appliance,
decoding the cooking instructions to acquire cooking parameters, said cooking parameters comprising a cooking time and a cooking power;
adjusting cooking appliance settings to the cooking time and the cooking power; and
activating the cooking appliance at the adjusted cooking appliance settings to prepare food based at least in part upon the acquired cooking parameters read from the data storage medium.

2. The method of claim 1, further comprising:
loading the data storage medium with said cooking instructions specific to the edible food;
packaging the edible food in the packaged food container for resale along with the loaded data storage medium; and
retailing the packaged food container at a point of sale retail outlet.

3. The method of claim 1, further comprising:
receiving input at the cooking appliance;
determining from the input an identity of a user of the cooking appliance;
querying a non-volatile memory of the cooking appliance for cooking preferences specific to the identified user; and
combining resultant user specific cooking preferences with the read cooking instructions to determine the cooking appliance settings of the adjusting step.

4. The method of claim 1, further comprising:
determining when reading the cooking instructions a plurality of different sets of cooking instructions each set being stored in the data storage medium, each set specific to a particular type of cooking appliance; and
ascertaining one of said sets of cooking instructions applicable to said cooking appliance, wherein said decoded cooking instructions comprise data of said ascertained one of said sets.

5. The method of claim 1, wherein said cooking instructions comprise at least two different cooking power settings, each associated with a different cooking time, wherein said cooking appliance settings are dynamically adjusted while food is being prepared so that a portion of the food preparation occurs at one of the two different cooking power settings for the associated cooking time and another portion of the food preparation occurs at another of the two different cooking power settings for the associated cooking time.

6. The method of claim 1, further comprising:
removing a food package from the packaged food container, wherein the food package is to be placed in the cooking appliance, wherein said data storage medium is part of the packaged food container that is not part of the food package to be placed in the cooking appliance.

7. The method of claim 6, wherein said part of the packaged food container comprising the data storage medium further comprises a battery, a transmitter powered by the battery, and a transmission activation switch, said method further comprising:
receiving a user activation of the transmission activation switch; and
responsive to the user activation, wirelessly transmitting via the transmitter the cooking instructions within a carrier wave, which is read by the cooking appliance.

8. The method of claim 1, wherein said cooking appliance is at least one of a microwave oven and a conventional oven, and wherein said data reader is a Radio Frequency Identification (RFID) reader that reads instructions from Radio Frequency Identification (RFID) tags included with packaged foods.

9. The method of claim 1, further comprising:
reading item identification information from the data storage medium;
decoding the item identification information; and
presenting the decoded item identification information within a display of the cooking appliance.

10. The method of claim 1, further comprising:
reading nutrition facts of the edible food from the data storage medium;
decoding the nutrition facts; and
presenting the decoded nutrition facts within a display of the cooking appliance, said nutrition facts comprising calories of the edible food, fat of the edible food, protein of the edible food, and vitamins of the edible food.

11. A packaged food item comprising:
edible food to be prepared by a cooking appliance; and
a data storage medium coupled to a package comprising the edible food, said data storage medium comprising digitally encoded cooking instructions able to be directly read by the cooking appliance, said digitally encoded cooking instructions defining cooking parameters for the cooking appliance, said digitally encoded cooking instructions comprising at least a cooking time and a cooking power for preparing the edible food.

12. The packaged food item of claim 11, said data storage medium further comprising encoded food identification data able to be directly read by the cooking appliance, said food identification data defining all food items by type that the edible food comprises.

13. The packaged food item of claim 11, said data storage medium further comprising nutrition facts of the edible food able to be directly read by the cooking appliance, said nutrition facts comprising calories of the edible food, fat of the edible food, protein of the edible food, and vitamins of the edible food.

14. The packaged food item of claim 11, said data storage medium comprising a plurality of different data sets, each data set comprising digitally encoded cooking instructions for a different type of cooking appliance for the edible food, said types of cooking appliances associated with an encoded instruction set comprising a conventional oven and a microwave, said digitally encoded cooking instructions comprising at least a cooking time and a cooking power for preparing the edible food for a particular type of cooking appliance.

15. The packaged food item of claim 11, further comprising:
a Radio Frequency Identification (RFID) tag coupled to said package comprising the edible food, said Radio Frequency Identification tag comprising said data storage medium.

16. The packaged food item of claim 11, further comprising:
a transmitter communicatively linked to the data storage medium and coupled to said package, said transmitter configured to wireless transmit said digitally encoded cooking instructions to said cooking appliance; and
a battery coupled to and powering said transmitter, said transmitter and said battery being coupled to said package in a separable manner so that when said edible food is placed in the cooking appliance said transmitter and said battery are outside said cooking appliance.

17. A cooking appliance comprising:
a cooking element for preparing food;
appliance circuitry for controlling a cooking power of the cooking element and a cooking time for which the cooking element is activated;
a data reader for reading cooking instructions from a data storage medium of a packaged food item, where said read cooking instructions are specific to edible food within a packaged food item; and
a processor for adjusting appliance settings in accordance with cooking instructions read by the data reader, where the adjusted appliance settings from the processor cause adjustments in the appliance circuitry, said adjustments comprising a cooking time and a cooking power.

18. The cooking appliance of claim 17, wherein said cooking appliance is able to read cooking instructions encoded in a data storage medium associated with packaged food, adjust at least one appliance setting based upon the read cooking instructions, and to prepare the packaged food based upon the adjusted appliance setting without requiring user input regarding instructions for the packaged food.

19. The cooking appliance of claim 17, comprising:
a non-volatile physical memory configured to store the at least one user-defined cooking preference; and
a user identification mechanism configured to identify a user of the cooking appliance, said processor determining user defined cooking preferences of a user from the non-volatile physical memory when preparing food and adjusting the appliance circuitry in a user specific way when preparing food based upon both the user-defined cooking preferences of the user and the cooking instructions read by the data reader.

20. The cooking appliance of claim 17, wherein said cooking appliance is at least one of a microwave oven and a conventional oven, and wherein said data reader is a Radio Frequency Identification (RFID) reader that reads instructions from Radio Frequency Identification (RFID) tags included with packaged foods.
